(19) United States
(12) Patent Application Publication
(10) Pub. No.: US 2006/0109103 A1
(43) Pub. Date: May 25, 2006

(54) Transmission technique for a portable alarm system

(76) Inventor: Robert Bradus, Bel Air, MD (US)

Correspondence Address: HARNESS, DICKEY & PIERCE, P.L.C., P.O. BOX 828, BLOOMFIELD HILLS, MI, 48303, US

(21) Appl. No.: 11/010,728

(22) Filed: Dec. 13, 2004

Related U.S. Application Data
(60) Provisional application No. 60/626,759, filed on Nov. 11, 2004.

(51) Int. Cl. G08B 1/00; G08B 23/00; G08B 1/08

(52) U.S. Cl. 340/531; 340/539.1; 340/533; 340/502

(57) ABSTRACT

A method is provided for transmitting an alarm message from a portable alarm system to a remote monitoring station. Upon determining an alarm condition, an alarm message is transmitted via a wireless communication link to a remotely located monitoring station. Prior to receiving an acknowledgement regarding the transmission sent over the wireless communication link, the alarm message is also transmitted to the monitoring station using a landline. This approach improves the likelihood that at least one alarm message sent from the alarm system will reach the monitoring station.

This application claims priority under 35 U.S.C. §119(e) to U.S. Provisional Application No. 60/626,759 filed on Nov. 11, 2004, and entitled “Transmission Technique for a Portable Alarm System” the specification and drawings of which are hereby expressly incorporated by reference.

### FIELD OF THE INVENTION

The present invention relates to a portable alarm system and, more particularly, to a method for transmitting an alarm message from a portable alarm system to a remote monitoring station.

### BACKGROUND OF THE INVENTION

In the security industry, alarm systems are available for monitoring a premises, such as a residential house or a commercial building. In operation, various types of sensors cooperatively operate with a control unit in order to detect security breaches. Upon detecting a security breach, the control unit may initiate an alarm in hopes of warding off any intruders as well as alerting those on the premises of the breach. In addition, the control unit may report the security breach to a remotely located monitoring station which in turn coordinates a response back to the premises.

Alarm messages are typically sent to the monitoring station using conventional land-based telephone lines. Unfortunately, an opportunity exists for an intruder to tamper with the telephone lines, thereby preventing transmission of an alarm message to the monitoring station. To address this concern, some alarm systems have begun to use wireless transmission techniques as either the primary communication link or as a backup to the land-based telephone lines. In some instances, these wireless links may also be unavailable to the alarm system.

To the extent that two communication links are available to an alarm system, a predefined protocol typically dictates which link is to be used first. More importantly, such protocols confirm availability and/or success of a transmission sent via a first type of link prior to attempting to send a message using the other type of available communication link. This additional confirmation step introduces an undesirable delay in the transmission of an alarm message. Likewise, a secondary transmission sent using the second type of link is only sent if the transmission using the first link fails.

Therefore, it is desirable to provide a faster and more reliable technique for transmitting alarm messages from an alarm system to a remote monitoring station.

### SUMMARY OF THE INVENTION

In accordance with the present invention, a method is provided for transmitting an alarm message from a portable alarm system to a remote monitoring station. Upon determining an alarm condition, an alarm message is transmitted via a wireless communication link to a remotely located monitoring station. Prior to receiving an acknowledgement regarding the transmission sent over the wireless communication link, the alarm message is also transmitted to the monitoring station using a landline. This approach improves the likelihood that at least one alarm message sent from the alarm system will reach the monitoring station.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a diagram illustrating an exemplary portable alarm system;

FIG. 2 is a block diagram showing an exemplary base unit configured with at least two different communication links; and

FIG. 3 is a flowchart illustrating a method an alarm message from a portable alarm system to a remote monitoring station in accordance with the present invention.

### DETAILED DESCRIPTION OF THE PREFERRED EMBODIMENTS

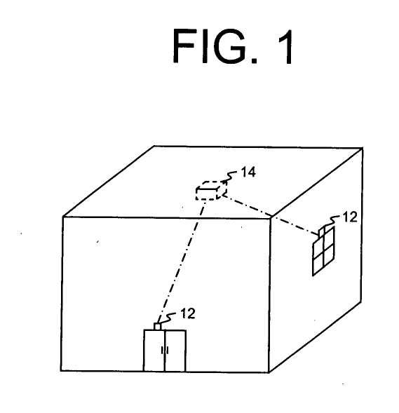

FIG. 1 illustrates an exemplary portable alarm system 10; The portable alarm system is comprised of one or more sensing devices 12 and a portable base unit 14. While the following description is provided with reference to a particular portable alarm system, it is readily understood that the transmission technique described below is suitable for other types of security systems having two or more types of available communication links.

Different types of sensing devices 12 may be used to monitor a premises. For example, a motion detector may be used to monitor a defined area on the premises; whereas, a vibration sensor may be used to sense when an object (e.g., tools or equipment on a construction jobsite) is being moved or otherwise disrupted. Upon detecting a triggering event, the sensor 12 communicates an event message to the base unit 14. Although event messages are preferably sent via a RF communication link, other types of wired and/or wireless communication links may be used to send event messages to the base unit 14. In addition, it is readily understood that other types of sensing devices may be employed by the portable alarm system.

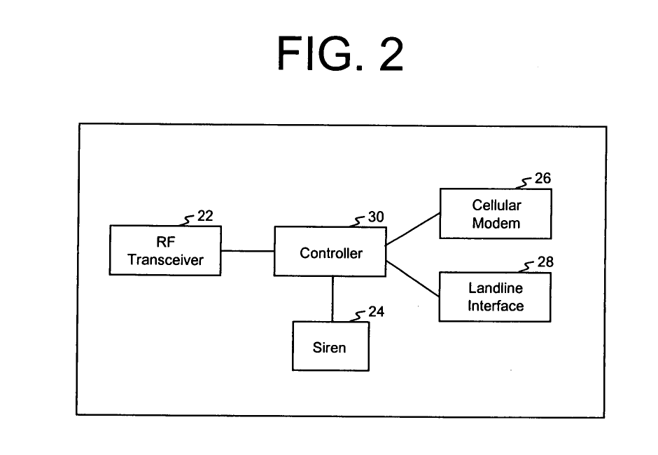

Referring to FIG. 2, an exemplary base unit 14 may be comprised of an RF transceiver 22, a siren 24, a cellular modem 26, a landline interface 28 and a controller 30. Although a few primary components of the base unit are discussed below, it is readily understood that other components known in the art may be needed to construct an operational base unit.

In this exemplary embodiment, event messages from the sensors are received by the RF transceiver 22 embedded in the base unit 14. Event messages are in turn passed on the controller 30, where an appropriate action may be taken. For example, in an armed condition the event message is indicative of an intrusion condition, and thus the controller 14 may activate the siren 24. In addition, the controller 30 may also report the alarm condition to a remotely located monitoring station. If the event message is not indicative of an alarm condition, then the event message may be disregarded or recorded in a log. It is also envisioned that acknowledgement messages as well as other types of status messages may be sent between the sensors and the base unit.

To transmit a message to the monitoring station, an appropriate alarm message is first formulated by the controller 30. The alarm message is then transmitted in accordance with the method further described below. To do so, the controller 30 interfaces with the cellular interface 26 (e.g., a cellular modem) as well as a land line interface 28 in a manner well known in the art.

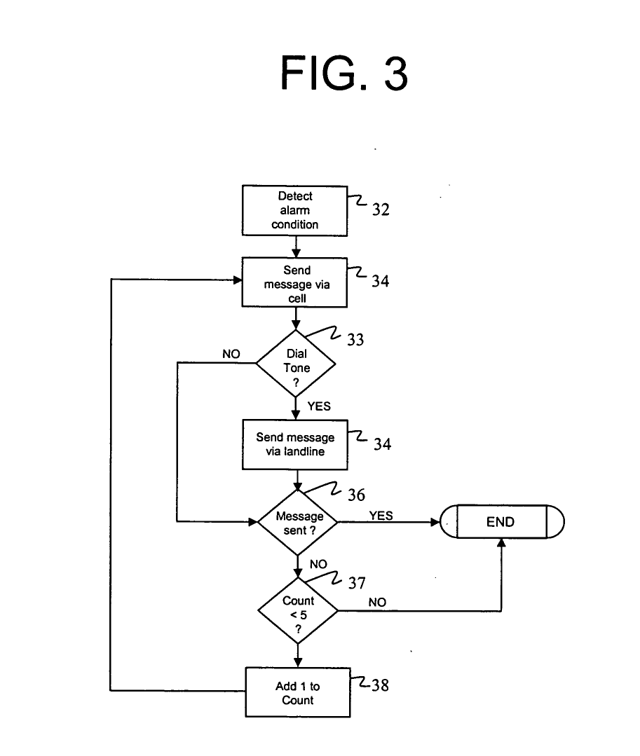

A method for transmitting messages from the portable alarm system to a remote monitoring station is further described in relation to FIG. 3. Upon determining the occurrence of an alarm condition, a message is prepared at 32 for transmission to the monitoring station. The alarm message is sent at 34 via the wireless communication link to the remote monitoring station.

In some instances, a landline connection may be available to the base unit. Thus, the base unit checks for the presence of a dial tone at 33. When a dial tone is present, the alarm message is also sent at 34 using the landline connection. The alarm message sent using the landline is preferably concurrent with or immediately following the transmission using the wireless link. Alternatively, it is contemplated that the alarm message may be sent via the landline connection first and then sent via the wireless link. Rather than using a landline connection, it is also contemplated that a secondary transmission may be sent via a different type of wired or wireless communication link.

Of particular importance, the alarm message is sent using the secondary transmission connection prior to receiving an acknowledgement regarding the transmission sent over the wireless communication link. In other words, the alarm message is sent without confirming the success or failure of the transmission sent over the wireless communication link. In this approach, the alarm message is sent quicker than in conventional approaches. In addition, this approach improves the likelihood that at least one alarm message sent from the alarm system will reach the monitoring station.

After attempting to send an alarm message, the base unit then verifies the success of each transmission at 36. In the case of the wireless transmission, an acknowledgement message will be sent by the recipient, thereby confirming receipt of the message. Thus, receipt of an acknowledgement message confirms receipt of the alarm message at the monitoring station. In the case of the landline connection, if the line was not dropped during the transmission, then the base unit may presume the alarm message was received by the monitoring station.

When either transmission of the alarm message is deemed successful, processing is complete as shown at 40. Conversely, if neither transmission was successful, then the base unit may repeat this transmission procedure for a predetermined number of times (e.g. five) as shown at 37.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for transmitting data from a portable alarm system to a remote monitoring station, comprising:
determining an alarm condition has occurred in an area being monitored by the portable alarm system;
transmitting an alarm message via a wireless communication link to a remotely located monitoring station; and
transmitting the alarm message to the monitoring station using a landline prior to receiving an acknowledgement regarding the transmission sent over the wireless communication link.

2. The method of claim 1 further comprises verifying the success of each transmission and re-transmitting the alarm message when both of the earlier transmissions failed.

3. The method of claim 1 further comprises monitoring receipt of an acknowledge message sent over the wireless communication link after transmitting the alarm message using a landline.

4. The method of claim 1 further comprises checking for presence of a dial tone on the landline prior to transmitting the alarm message using the landline.

5. A method for transmitting data from a portable alarm system to a remote monitoring station, comprising:
determining an alarm condition has occurred in an area being monitored by the portable alarm system;
transmitting an alarm message via a wireless communication link to a remotely located monitoring station; and
concurrently transmitting the alarm message to the monitoring station using a landline.

6. The method of claim 5 further comprises verifying the success of each transmission and re-transmitting the alarm message when both of the transmissions failed.

7. The method of claim 5 further comprises monitoring receipt of an acknowledge message sent over the wireless communication link after transmitting the alarm message using a landline.

8. The method of claim 5 further comprises checking for presence of a dial tone on the landline prior to transmitting the alarm message using the landline.

9. A method for transmitting data from a portable alarm system to a remote monitoring station, comprising:
determining an alarm condition has occurred in an area being monitored by the portable alarm system;
transmitting an alarm message via a primary communication link to a remotely located monitoring station; and
transmitting the alarm message to the monitoring station using a secondary communication link prior to receiving an acknowledgement regarding the transmission sent over the primary communication link.

10. The method of claim 9 further comprises verifying the success of each transmission and re-transmitting the alarm message when both of the transmissions failed.

11. The method of claim 9 further comprises monitoring receipt of an acknowledge message sent over the primary communication link after transmitting the alarm message using the secondary communication link.
